(19) United States
(12) Patent Application Publication
(10) Pub. No.: US 2014/0009988 A1
(43) Pub. Date: Jan. 9, 2014

(54) Modulation of Multi-Phase Inverter

(71) Applicant: Massimo Valiani, Corciano (PG) (IT)

(72) Inventor: Massimo Valiani, Corciano (PG) (IT)

(73) Assignee: Power-One Italy S.p.A., Terranuova Bracciolini (IT)

(21) Appl. No.: 13/981,106

(22) PCT Filed: Feb. 1, 2011
(86) PCT No.: PCT/IT2011/000025

§ 371 Date: Sep. 24, 2013

(51) Int. Cl. H02M 7/537

(52) U.S. Cl. CPC H02M 7/537
USPC 363/131

(57) ABSTRACT

The multi-phase inverter modulating method provides for calculating a duty cycle vector (D) calculated as a function of electric parameters defining a rotating vector (Vo) representative of an output electric quantity required from the inverter, is multiplied for a stored modulation matrix to obtain a plurality of duty cycle signals for a plurality of electronic switches of said inverter.

### TECHNICAL FIELD

The present invention relates to inverters, in particular single or multi-level multi-phase inverters. More specifically, the invention relates to the generation of a control that exploits the space vector modulation principle.

### STATE OF THE ART

Modulation is the operation that allows the operation of electric machines based on the PWM (Pulse Width Modulation) principle. Many electric machines use the PWM to produce an output voltage whose profile over time has the desired shape (for example, but not necessarily, sinusoidal) and it is used to supply power to other machines, for example electric motors or to transfer electrical energy on a distribution grid. In general, the electric machine powered by the inverter needs to receive an input voltage with variable modulus and frequency; in the case of an electric motor, for example, this is carried out to vary the rotation speed of the motor as a function of specific operating conditions. Modulation consists of a continuous comparison over time between a high frequency carrier and a low frequency modulating waveform. The signal obtained from this comparison is used to drive the opening and closing of the electronic switches of the inverter.

Modulation techniques can be of various kinds. The present invention relates in particular to improvements to the technique based on the projection of the voltage vector to be obtained on a vector base, also called vector control, whose basic principles will be summarized below, before describing in detail some embodiments of the improved method of the invention.

The number of controlled electronic switches of an electric machine rises with the increase in the number of voltage levels and with the number of phases. The higher the number of switches, the greater the complexity of the driving system, with consequent high computational loads. This limits the number of switches that can be present in an electric machine of this type or, conversely, it requires the use of particularly expensive logic circuits or microswitches. However, a higher number of voltage levels enables to reduce the harmonic content of the output voltage from the inverter, with an advantage in terms of operation and quality of the resulting electric current.

Examples of space vector PWM applied to various types of multi-phase and multi-level inverters, are reported in H. Djeghloud et al, “Space Vector Pulse Width Modulation Applied to the Three-level Voltage Inverter”, available at http://icta05.teithe.gr/papers/52.pdf and in H. Pinheiro et al, “Space Vector Modulation for Voltage-Source Inverters: A Unified Approach”, available at http://ieeexplore.ieee.org/xpl/freeabs_all.jsp?arnumber=1187476

### SUMMARY OF THE INVENTION

According to one aspect, the present invention provides a method for driving the switches of multi-phase and multi-level machines that is particularly efficient and simple to implement.

In one embodiment, the invention provides a method for modulating a multi-phase inverter, in which a duty cycle vector calculated as a function of electric parameters defining a rotating vector representing an output electric quantity required from the inverter, is multiplied by at least one memorized modulation matrix to obtain a plurality of duty cycle signals for a plurality of electronic switches of said inverter. The modulation matrices are determined by the characteristics of the inverter, in particular by the number of phases of the inverter and by the number of voltage levels of the inverter, as well as by the set of state vectors used for the modulation, as will become more readily apparent from the detailed description of some embodiments of the method according to the invention.

Therefore, these matrices substantially constitute sets of binary numbers in matrix form, defined by the circuit characteristics of the inverter and by the set of vectors used for modulation.

In some embodiments, the modulation matrices do not vary during driving of the inverter. However, it is possible to memorize multiple sets of modulation matrices and to use one or the other of these sets according to the operating conditions, hence varying the modulation matrices used over time.

As will become readily apparent below, the matrices can also be represented in compressed form, with an extremely reduced memory occupation. The modulation matrices can be obtained from the compressed matrices with simple shift and rotation operations, which require limited calculation times and resources, available also on controllers with modest capabilities and limited cost.

The modulation matrices, even in the compressed form, can easily be written in decimal notation, thereby simplifying programming and data storage.

In practice, the rotating vector can be representative of any electric quantity as a function of which the inverter is controlled. In preferred embodiments of the invention, the electric quantity is a voltage, typically a three-phase voltage.

The invention can also be applied to current-controlled inverters and/or to inverters with more than three phases.

Characteristically, according to the invention the method provides a plurality of modulation matrices equal to a multiple of a number of sectors into which the complex plane is subdivided, the rotating vector being represented in said complex plane. In some embodiments, the complex plane is subdivided into six sectors. The number of modulation matrices depends on the number of levels of the inverter. More in particular, the number of matrices is typically equal to the number of sectors multiplied by (L−1), where L is the number of levels of the inverter.

According to one aspect, the invention relates to a multi-phase inverter modulation method comprising the steps of
storing data defining a plurality of modulation matrices;
for each PWM cycle, determining a modulation index and a phase angle of a rotating vector representative of an output electric quantity required from the inverter;
determining in which sector of a complex plane said rotating vector is located;
calculating a duty cycle vector on the basis of the phase angle and of the modulus of said rotating vector;
performing a matrix multiplication between the duty cycle vector and at least one modulation matrix corresponding to said sector to obtain a plurality of duty cycles for a plurality of electronic switches of said inverter;
loading said duty cycles in a PWM modulator of said inverter and generating, using this PWM modulator, physical signals for driving said switches based on said duty cycles.

In some embodiments, the method provides that for each sector into which the complex plane is subdivided, data are stored for the determination of a number of modulation matrices that depends on the number of levels of the inverter, and in which each modulation matrix comprises a number of rows equal to a number of state vectors lying on the edges of each sector into which said complex plane is subdivided and a number of columns equal to the number of branches of the inverter. The number of branches of the inverter can be equal to or higher than the number of phases of the inverter. For example, the inverter can be a three-phase inverter and have a fourth branch connected to neutral.

In some embodiments, the modulation method comprises the steps of:
determining a rotating vector representative of the multi-phase output voltage of the inverter, said rotating vector being defined by a modulation index and by an electric angle in a complex plane;
at each PWM cycle, determining the sector of said complex plane in which said rotating vector is positioned;
determining a modified phase angle, offsetting the phase of the rotating vector until said rotating vector and the sector in which it lies are brought back to a geometric condition coinciding with that of the first sector of the complex plane;
calculating the duty cycle vector as a function of the modified phase angle and of the modulation index of the rotating vector;
effecting a row by column product of the duty cycle vector and the modulation matrices;
loading the values obtained from the product between the duty cycle vector and the modulation matrices in a PWM modulator;
driving the switches of the inverter as a function of the output PWM signals from said modulator.

The invention also relates to an electric power conversion system comprising: a multi-phase inverter connected the input of which is connected to a source of electric energy and the output of which is connected to an electric grid; a control system comprising a PWM modulator; wherein said control system calculates the duty cycle according to the method defined above.

### BRIEF DESCRIPTION OF THE DRAWINGS

The invention shall be better understood following the description and the accompanying drawing, which shows practical non-limiting embodiments of the present invention. More in particular, in the drawing:

FIG. 1A shows a profile of the wave form of a modulating wave and of a carrier wave as well as the PWM signal obtained from the comparison between the carrier wave and the modulating wave;

FIG. 1B shows a diagram of a three-phase three-level inverter for driving an electric motor with star connection (purely by way of example);

FIG. 2 shows a complex plane in which the state vectors of a three-phase three-level inverter are located;

FIG. 3 shows the complex plane of FIG. 2, in which four state vectors, which are discarded in the preferred embodiment of the invention, have been eliminated;

FIG. 4 shows the complex plane of FIG. 3 with a rotating vector, to be obtained at the output of the inverter, in generic position;

FIG. 5 shows the diagram of the three-phase inverter of FIG. 1B with the indication of the switch driving signals;

FIG. 6 shows a chart of a two-level three-phase inverter;

FIG. 7 shows the complex plane of the state vectors in the case of two-level three-phase inverters of FIG. 6;

FIG. 8 shows the complex plane with all state vectors of a three-level three-phase inverter, and a rotating vector;

FIG. 9 shows a block diagram of a system using a three-phase inverter that can be controlled using the modulation method of the present invention.

### DETAILED DESCRIPTION OF AN EMBODIMENT

### Modulation Theory

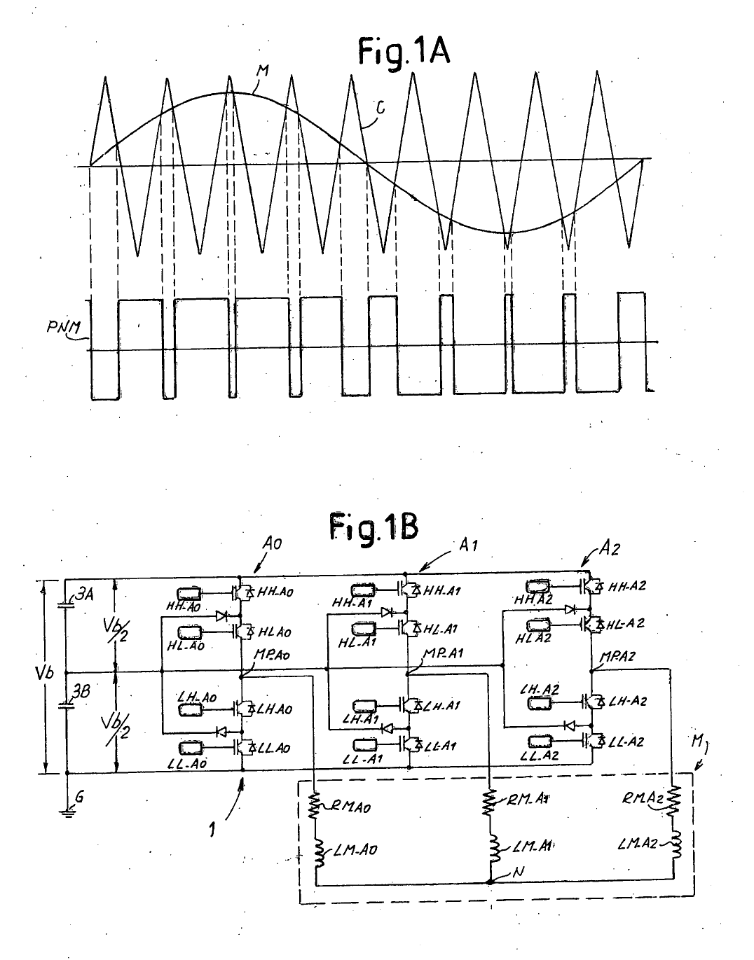

For a better understanding of the present invention, with initial reference to FIGS. 1A and 1B, initially reference will be made to some fundamentals of modulation theory applicable to this type of machines. FIG. 1A shows the profile of the wave form of a carrier wave (C) and the profile of the wave form of a modulating wave (M) that, compared to each other, generate the PWM signal for driving an inverter. By driving the switches of the inverter with a PWM signal of this type, an output voltage is obtained, whose average value within the repetition period of the carrier wave approximates the sinusoidal profile of the modulating wave M.

FIG. 1B shows a diagram of a PWM inverter with three phases, three branches and three levels. The input of the inverter can be connected to a direct voltage source, for example a photovoltaic panel, whilst the output of the inverter can be connected to an electric distribution grid or to a generic three-phase machine.

At the input of the inverter, indicated in its entirety by the reference number 1, is applied a stabilized direct voltage Vb, hereafter indicated as bulk voltage. The bulk voltage is stabilized by two capacitors 3A, 3B. The number of input capacitors depends on the number of voltage levels of the inverter. In the case of an inverter with L levels, the number of input capacitors is L−1. At the terminals of each of the two capacitors 3A, 3B, a voltage equal to ½Vb is established. The bulk voltage is subdivided into N+1 different levels where N is the number of capacitors. As known from the prior art, the harmonic content of the inverter output voltage is the smaller (i.e., the output voltage approaches the more closely a sinusoidal wave at the basic frequency), the higher the number of voltage levels available due to the presence of inverter input capacitors.

In this case, the inverter is three-phase and it comprises three branches, each of which has four electronic switches. The three branches are generically indicated with A0, A1, and A2 respectively. The number of electronic switches for each branch is determined by the number of levels of the inverter. For a generic inverter with L levels, the number of switches per phase is 2(L−1). The switches are distributed symmetrically above and below the central point MP_{A0}, MP_{A1}, MP_{A2} of each phase. In the diagram of FIG. 1B, the two switches that are located between the positive terminal and the central point of the respective branch are indicated with HH and HL, whilst those that are located between the central point and the negative terminal are indicated with LH and LL. Hence, the switches of the branch A0 are indicated with HH_A0; HL_A0; LH_A0; LL_A0, whilst those of the branches A1 and A2 are indicated with HH_A1; HL_A1; LH_A1; LL_A1 and respectively HH_A2; HL_A2; LH_A2; LL_A2.

In the illustrated example, the three outputs MP_{A0}, MP_{A1}, MP_{A2} of the inverter power a balanced three-phase load. In FIG. 1B, this load is a three-phase motor M with an inaccessible neutral N, schematically represented by three branches, each containing a resistance RM_{A0}, RM_{A1}, RM_{A2} and an inductance LM_{A0}, LM_{A1}, LM_{A2} positioned in series. The neutral N is floating relative to the ground G of the inverter 1.

Each electronic switch can alternatively take up the two states of open and closed. Therefore, since each branch contains four controlled switches, for each branch A0, A₁, A₂ of the three-level inverter 1, in theory 16 different states or conditions are possible, each defined by a different combination of the states (open or closed) of the four switches. In general, for an inverter with L levels, theoretically 4(L−1)² states or conditions will be possible.

However, since each state corresponds to a determined condition of electric connection of the machine, some of these states are inadmissible because they would lead to electrically unacceptable conditions or behaviors of the inverter. Eliminating all these inadmissible states, only the states of a subset of the 16 theoretically definable states are found to be actually compatible with the correct operation of the machine. It is known from the prior art that for an L-level inverter, there are only L admissible states for each branch. For a generic branch of the three-level inverter of FIG. 1B, these are defined in the following Table 1:

TABLE 1

| | | | | | State number |
|---|---|---|---|---|---|
| HH State | HL State | LH State | LL State | Vout | of the branch |
| 1 | 1 | 0 | 0 | +Vb | 2 |
| 0 | 1 | 1 | 0 | +Vb/2 | 1 |
| 0 | 0 | 1 | 1 | 0 | 0 |

Each state is defined by a row of the Table 1. The states of the generic branch (A₀, A₁, A₂) of the inverter 1 are respectively indicated as 2, 1 and 0. The state number is indicated in the last column. The next to last column shows the output voltage with respect to the corresponding point G, and the first four columns show the conditions (open=0 or closed=1) of the four switches. The four conditions of the four switches indicated in a single row define the state (0, 1 or 2) of the branch of the inverter. The switch is identified by the acronym HH, HL, LH, LL in the header of the table. Thus for example the first row indicates that in the state “2” of a generic branch of the inverter 1 the switches between the positive terminal and the central point MP (in the case of the branch A₀ the switches HH_A₀, HL_A₀) are closed, whilst the switches between the negative terminal and the central point (in the case of the branch A₀, the switches LH_A₀ and LL_A₀) are open.

There is a relationship between the output voltage of a generic branch of the inverter with respect to the point G and the state (0, 1, 2) taken by the branch. In the case of a three-level inverter, there are three possible values of the output voltage (0, ½Vb and Vb) for the three states 0, 1 and 2, respectively. This relationship can be generalized. For a generic L-levels inverter it can be demonstrated that the output voltage Vout(i) relative to the point G for the generic state “i” of the inverter is given by:

$$Vout ( i ) = Vb * \frac{i}{L - 1} where \text{:} 0 \leq i \leq L - 1 \qquad ( 1 )$$

Moreover, it can easily be demonstrated that inside each of the three branches A₀, A₁, A₂ the state of the switch LH is the negation of the state of the switch HH and the state of the switch LL is the negation of the state of the switch HL. This can be briefly indicated as follows:

LH=NOT(HH)

LL=NOT(HL) (2)

In fact, observing Table 1 above, when the switch HH is closed (state 1), the switch LH is open (state 0) and vice versa. Similarly, when the switch LL is closed the switch HL is open and vice versa.

Therefore, since there is a relationship between the states of pairs of switches, although in theory four variables are necessary to define the state of the branch (one variable for each of the four switches), in fact two variables for each branch are sufficient. These variables can be associated to the driving signals of only the switches HH and HL respectively. The driving signals of the switches LH and LL are derived from those of the switches HH and HL on the basis of the aforesaid logic negation relationship.

This property also holds true for an inverter that has a generic number of levels L. The state of each branch of such a generic L-level inverter can be defined by L−1 variables.

Hereafter, these variables for the example of three-phase three-level inverter shall be indicated as S₀_{_{—}}ₓeS₁_{_{—}}ₓ, where the subscript x identifies the branch A₀, A₁, A₂. Hence, the state of a generic branch x of the inverter is defined by a two-dimension vector S_x=(S₀_{_{—}}ₓ; S₁_{_{—}}ₓ). For an L-level inverter, vice versa, there will be L−1 variables for each branch x

S_{—}x=(S₀_{_{—}}ₓ,S₁_{_{—}}ₓ, . . . ,S_{L-2}_{_{—}}ₓ) (3)

In view of these considerations, the conclusion is that a three-phase inverter can be described by a state vector having the following form:

(A₀,A₁,A₂) (4)

where each component A₀, A₁, A₂ of the vector indicates the state of one of the three branches of the inverter. As noted above, each component can take a value 0, 1 or 2 that corresponds to one of the three states indicated in Table 1. For example for the inverter of FIG. 1B the vector

(A₀,A₁,A₂)=1,0,0 (5)

indicates the following condition of the switches in the three branches:

(HH_A₀,HL_A₀,LH_A₀,LL_A₀,HH_A₁,HL_A₁,LH_A₁,LL_A₁,HH_A₂,HL_A₂,LH_A₂,LL_A₂)==(0,1,1,0,0,0,1,1,0,0,1,1) (6)

As is readily apparent from Table 1 above, the output voltage, on the central point MP_{A0}, MP_{A1}, MP_{A2} of the three branches with respect to the point G is equal to:

Vout_{A}_{₀}=Vb/2

Vout_{A}_{₁}=0

Vout_{A}_{₂}=0 (7)

These considerations can be generalized to a three-phase L-levels inverter, for which there will be the following output voltages with respect to the point G (indicating as (i_{A0}, i_{A1}, i_{A2}) the state vector that describes the entire inverter):

$$\begin{matrix}{Vout}_{{A}_{0}} = Vb * \frac{{i}_{{A}_{0}}}{L - 1} \\ {Vout}_{{A}_{1}} = Vb * \frac{{i}_{{A}_{1}}}{L - 1} \\ {Vout}_{{A}_{2}} = Vb * \frac{{i}_{{A}_{2}}}{L - 1}\end{matrix} \qquad ( 8 )$$

The three output voltages power a balanced three-phase load and hence the concatenated voltage is equal to zero. I.e.:

$${V}_{{A}_{0} \_ N} + {V}_{{A}_{1} \_ N} + {V}_{{A}_{2} \_ N} = 0 \qquad ( 9 )$$

where V_{Ai}_{_{—}}_{N} indicates the voltage across the neutral of the load (indicated as point N in FIG. 1B) and the output of the generic phase “i” of the inverter. Hence, considering the common mode voltage between the ground G and the neutral N (V_{GND}_{_{—}}_{N}), the following is obtained:

$${V}_{{A}_{0} \_ N} = {Vout}_{{A}_{0}} + {V}_{GND \_ N} \\ {V}_{{A}_{1} \_ N} = {Vout}_{{A}_{1}} + {V}_{GND \_ N} \\ {V}_{{A}_{2} \_ N} = {Vout}_{{A}_{2}} + {V}_{GND \_ N} \qquad ( 10 )$$

Summing these three equations and using the property of null concatenation expressed by (9), the following is obtained:

$${V}_{GND\_N} = - \frac{{Vout}_{{A}_{0}} + {Vout}_{{A}_{1}} + {Vout}_{{A}_{2}}}{3} \qquad ( 11 )$$

and substituting the output voltage of each phase with its expression as a function of the bulk voltage Vb and of the state “i”, the following is obtained:

$${V}_{GND\_N} = - \frac{Vb}{3 * ( L - 1 )} ( {i}_{{A}_{0}} + {i}_{{A}_{1}} + {i}_{{A}_{2}} ) \qquad ( 12 )$$

Therefore, the voltages across the output of each phase and the neutral point N are:

$${V}_{{A}_{0} \_N} = \frac{Vb}{3 * ( L - 1 )} * ( 2 * {i}_{{A}_{0}} - {i}_{{A}_{1}} - {i}_{{A}_{2}} ) \\ {V}_{{A}_{1} \_N} = \frac{Vb}{3 * ( L - 1 )} * ( 2 * {i}_{{A}_{1}} - {i}_{{A}_{0}} - {i}_{{A}_{2}} ) \\ {V}_{{A}_{2} \_N} = \frac{Vb}{3 * ( L - 1 )} * ( 2 * {i}_{{A}_{2}} - {i}_{{A}_{0}} - {i}_{{A}_{1}} ) \qquad ( 13 )$$

Summarizing, the voltage across each phase of the inverter and the neutral of the load can be expressed as a function of the bulk voltage Vb and of the state (i_{A0}, i_{A1}, i_{A2}) of each branch of the inverter, which in the case of the three-level inverter of FIG. 1 can take the values 0, 1, 2 alternatively for each phase.

This set of three voltage values for the three phases can be represented with a vector representation applying the Clarke transform. The in-phase and quadrature components of the voltage vector that is obtained applying the Clarke transform, are:

$${V}_{α} = k * ( {V}_{{A}_{0} \_N} - \frac{{V}_{{A}_{1} \_N} + {V}_{{A}_{2} \_N}}{2} ) \\ {V}_{β} = k * \frac{\sqrt{3}}{2} * ( {V}_{{A}_{1} \_N} - {V}_{{A}_{2} \_N} ) \qquad ( 14 )$$

and applying the expressions of the voltages across phase and neutral expressed as a function of the states of the three phases of the inverter, the following is obtained:

$${V}_{α} = \frac{Vb}{L - 1} ( {i}_{{A}_{0}} - \frac{{i}_{{A}_{1}} + {i}_{{A}_{2}}}{2} ) \\ {V}_{β} = \frac{\sqrt{3}}{2 } \frac{Vb}{L - 1} * ( {i}_{{A}_{1}} - {i}_{{A}_{2}} ) \qquad ( 15 )$$

having selected k=1 in order to have a mathematical transformation that maintains the modules of the voltages.

In the general case of an L-level inverter, the above equations lead to define L³ different vectors, some of which, however, coincide with each other in the complex plane. In the case of a three-level inverter, the 27 (3³) vectors are reduced to 19 different vectors.

In general, it can be demonstrated that in the complex plane for a generic three-phase L-level inverter a number of effective, i.e. mutually different, vectors is identified, defined by

SVM_{—}Vec_Num=3*L*(L−1)+1 (16)

and for L=3 (three-level inverter), the vectors are limited to 19.

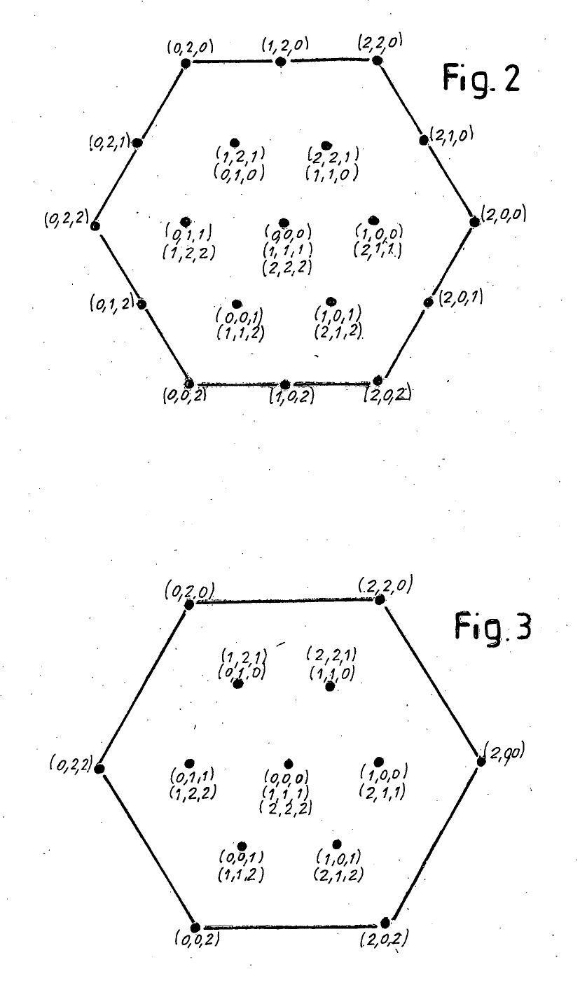

FIG. 2 shows the complex plane in which the 27 state vectors that define the conditions of the three-phase three-level inverter are represented. In practice, the diagram shows 27 points of the complex plane that represent the end of as many vectors, each of which represents the output voltage of the inverter relative to the neutral N when it takes a condition defined by the set of three values (so-called “state triplet”) indicated in parentheses next to each point, where each set of three is defined in (4), and each component of a set of three represents the pair of values (S₀_{_{—}}ₓ; S₁_{_{—}}ₓ) defined in (3).

It is noted that, as indicated above, the number of mutually different vectors is lower than the number of states of the inverter and that the total number of mutually distinct vectors is 19.

### Application to the Three-Phase Three-Level Inverter

Starting from what has been summarized so far, which is known from the prior art and constitutes the theory on which the vector modulation of the inverter is based, in a particularly advantageous embodiment of the invention the first step of the method according to the invention consists of reducing the number of vectors in the complex plane that are used for modulation. More in particular, observing that all vectors are located on rays offset by 60 electric degrees from each other, except the vectors represented by the state triplets (2,1,0), (0,2,1), (0,1,2), (2,0,1), these four vectors will be eliminated (see FIG. 2 in this regard).

FIG. 3 represents in the complex plane the 21 vectors that will be used in this preferred embodiment of the method according to the invention. This choice does not set particular limitations, because the vectors that represent the output voltage of the inverter are all those that are inside the circle inscribed in the hexagon represented in the diagram of FIG. 3, which can provide the highest possible modulation index.

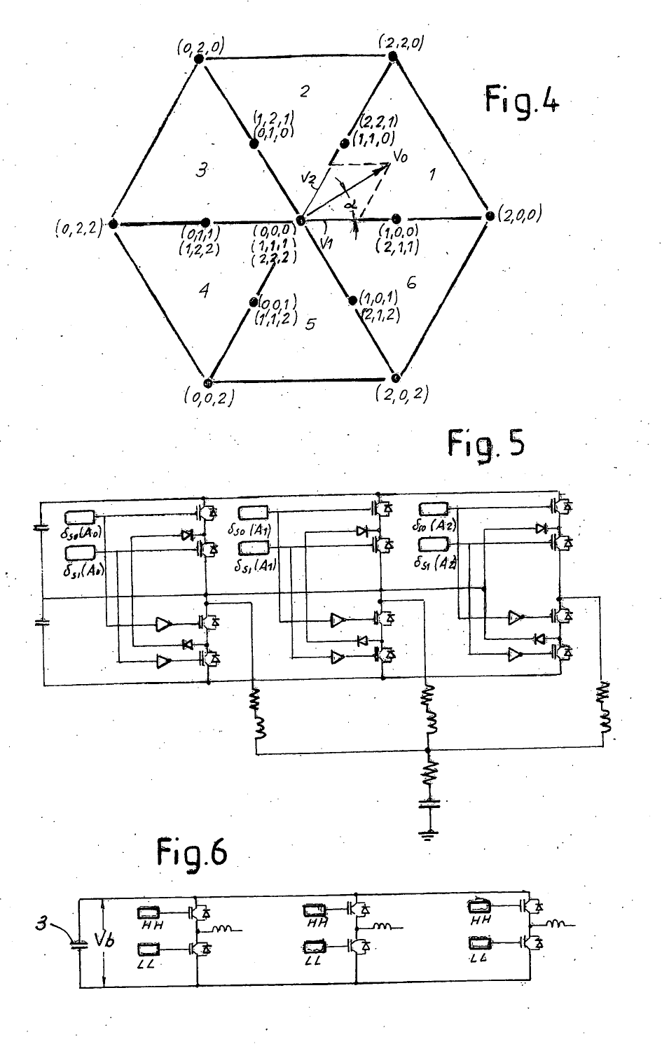

In the diagram of FIG. 3, six sectors can be identified, each of which spans over 60 electric degrees. The six sectors are indicated in FIG. 4 and numbered from 1 to 6.

Now consider the rotating vector V₀ in the diagram of FIG. 4, which represents the three-phase voltage output from the inverter 1 after the application of the Clarke transform. The rotating vector V₀ can be associated to one of the sectors into which the diagram is subdivided. Preferably, the rotating vector is associated to the sector inside which it is located. For example, in the state of FIG. 4 the rotating vector V₀ is associated to sector no. 1.

The rotating vector V₀ can be projected on the sides of the relevant sector, in order to identify the two components V₁ and V₂ of the rotating vector V₀, i.e. the two projections of the rotating vector on the rays that delimit the sector in which the rotating vector V₀ is located in the instant considered. On the basis of simple trigonometric considerations, being a the angle between the rotating vector and the positive half of the abscissa axis, as indicated in FIG. 4, the following relationships are obtained:

$${V}_{1} = \frac{{MV}_{b}}{2} * ( \sqrt{3} cos α - sin α ) \\ {V}_{2} = {MV}_{b} * sin α \\ where \text{:} \\ M = \frac{{V}_{o}}{Vb} \qquad ( 17 )$$

The quantity M indicates the ratio between the amplitude of the rotating vector and the bulk voltage Vb and represents the modulation index which may vary between 0 and \sqrt{3}/2, value which is taken when the rotating vector V₀ has one end thereof on the circumference inscribed in the hexagon of FIG. 4. This condition corresponds to the maximum output voltage across phase and neutral N equal to

$$\frac{\sqrt{3}}{2} Vb$$

and phase-phase voltage equal to Vb.

The rotating vector V₀ is then obtained synthesizing in each instant the components V₁, V₂ of the vector on the rays defining the sector in which the rotating vector V₀ is located instantaneously, modulating the opening and the closing of the electronic switches of the three branches of the inverter. Since each switching condition of the switches of the inverter corresponds to one of the states represented by the 21 vectors shown in the complex plane of FIG. 4, essentially to obtain the voltage represented by the rotating vector V₀ it is necessary adequately to combine the states of the inverter, to obtain the components V₁, V₂ of the rotating vector V₀.

With reference to the instant represented in FIG. 4, the vector V₁ can be synthesized using various possible combinations of the state vectors (2,0,0), (1,0,0) and (2,1,1). In particular, the vector V₁ can be obtained with one of the following combinations:
1. using solely the vector (2,0,0) applied for a duty cycle of

$${δ}_{1} = \frac{{V}_{1}}{Vb}$$

2. using only the vector (1,0,0) (only if

$$\vert {V}_{o} \vert \leq \frac{Vb}{2} )$$

applied for a duty cycle equal to

$${δ}_{1} = \frac{{V}_{1}}{Vb / 2}$$

3. using only the vector (2,1,1) (only if

$$\vert {V}_{o} \vert \leq \frac{Vb}{2} )$$

applied for a duty cycle equal to

$${δ}_{1} = \frac{{V}_{1}}{Vb / 2}$$

4. using the vectors (2,0,0) and (1,0,0) and (2,1,1) in linear combination.

To obtain the maximum performance in terms of harmonic content and uniformity of the switching signal, in a preferred embodiment the method according to the invention uses the linear combination of the three vectors (2,0,0), (1,0,0) and (2,1,1). More in particular, in preferred embodiments of the invention the vector (2,0,0) is used to accomplish half of the projection of the vector V₁, and the vectors (1,0,0) and (2,1,1) each to accomplish one fourth of the remaining projection.

The duty cycles associated to this choice are the following:

$$( 2 , 0 , 0 ) \to {δ}_{1}^{1} = \frac{{V}_{1}}{2} \frac{1}{Vb} \\ ( 1 , 0 , 0 ) \to {δ}_{1}^{2} = \frac{{V}_{1}}{4} \frac{1}{Vb / 2} = \frac{{V}_{1}}{2} \frac{1}{Vb} \\ ( 2 , 1 , 1 ) \to {δ}_{1}^{3} = \frac{{V}_{1}}{4} \frac{1}{Vb / 2} = \frac{{V}_{1}}{2} \frac{1}{Vb} \qquad ( 18 )$$

Note that the three duty cycles have the same value, which will be indicated as δ₁.

Similar considerations can be made for the component V₂, obtaining the following duty cycle values to synthesize the vector V₂:

$$( 2 , 2 , 0 ) \to {δ}_{2}^{1} = \frac{{V}_{2}}{2} \frac{1}{Vb} \\ ( 1 , 1 , 0 ) \to {δ}_{2}^{2} = \frac{{V}_{2}}{4} \frac{1}{Vb / 2} = \frac{{V}_{2}}{2} \frac{1}{Vb} \\ ( 2 , 2 , 1 ) \to {δ}_{2}^{3} = \frac{{V}_{2}}{4} \frac{1}{Vb / 2} = \frac{{V}_{2}}{2} \frac{1}{Vb} \qquad ( 19 )$$

In this case, too, the three duty cycles have the same value, which will be indicated with δ₂.

To assure the physical coherence of the projection in the vector space, the residual time (if existing) of the PWM cycle is assigned to the vectors (0,0,0), (1,1,1) and (2,2,2) as follows:

$${δ}_{3} = \frac{1 - {δ}_{1} - {δ}_{2}}{3} \\ ( 0 , 0 , 0 ) \to {δ}_{3} \\ ( 1 , 1 , 1 ) \to {δ}_{3} \\ ( 2 , 2 , 2 ) \to {δ}_{3} \qquad ( 20 )$$

With a simple substitution of (17) in (18), (19) and (20) and remembering that the modulation index M is equal to Vₒ/V_{b}, the following is obtained:

$${δ}_{1} = \frac{M}{4} ( \sqrt{3} cos α - sin α ) \\ {δ}_{2} = \frac{M}{2} sin α \\ {δ}_{3} = \frac{1 - {δ}_{1} - {δ}_{2}}{3} \qquad ( 21 )$$

Briefly, this means that in a given PWM cycle, to generate the vector V₀ the nine vectors representing nine states of the inverter are combined; they are identified by the vectors (2,0,0); (1,0,0); (2,1,1); (0,0,0); (1,1,1); (2,2,2); (2,2,0); (2,2,1); (1,1,0), i.e. the vectors that are located on the two rays that in the complex plane (FIG. 3) define the sector in which the rotating vector V₀ is located. Each of these vectors corresponds to a state triplet of the inverter and each state triplet identifies for each branch of the three-phase inverter the state assumed by the four switches of the branch. The three duty cycle values δ¹, δ₂, δ₃ are those obtained from the above formulas (19), (20) and (21).

From what has been described above with respect to the modulation theory, see in particular Table 1, it has been seen that for a three-phase three-level inverter, two variables are sufficient for each phase in order to obtain the correct driving of the inverter switches, which variables can be associated to the driving signals of the switches HH and HL respectively. From Table 1, associating to each state number Aₓ the respective variables S₀_{_{—}}ₓ and S₁_{_{—}}ₓ, the following relationship between the state number and the state variables is obtained.

TABLE 2

| State number for the generic branch Aₓ | Variable S₀_x | Variable S₁_x |
|---|---|---|
| 0 | 0 | 0 |
| 1 | 0 | 1 |
| 2 | 1 | 1 |

In a three-phase inverter, three tables of this kind can be written, one for each branch of the inverter. This means that two vectors with three components each can be associated to each state (A₀, A₁, A₂) of the inverter. For example, for the state (A₀, A₁, A₂)=(2,0,0), the following is obtained

(2,0,0)→ S̅₀=(1,0,0) S̅₁=(1,0,0) (22A)

and for the state (A₀, A₁, A₂)=(2,1,1), the following is obtained

(2,1,1)→ S̅₀=(1,0,0) S̅₁=(1,1,1) (22B)

Returning to the vector representation of FIG. 4, the nine vectors lying on the rays defining the sector 1 (between 0 and 60 degrees) used to calculate the projections of the rotating vector V₀ can be described by the following vector system:

(2,0,0)→ S̅₀=(1,0,0) S̅₁=(1,0,0)

(1,0,0)→ S̅₀=(0,0,0) S̅₁=(1,0,0)

(2,1,1)→ S̅₀=(1,0,0) S̅₁=(1,1,1)

(2,2,0)→ S̅₀=(1,1,0) S̅₁=(1,1,0)

(1,1,0)→ S̅₀=(0,0,0) S̅₁=(1,1,0)

(2,2,1)→ S̅₀=(1,1,0) S̅₁=(1,1,1)

(0,0,0)→ S̅₀=(0,0,0) S̅₁=(0,0,0)

(1,1,1)→ S̅₀=(0,0,0) S̅₁=(1,1,1)

(2,2,2)→ S̅₀=(1,1,1) S̅₁=(1,1,1) (23)

The 18 vectors with dimensions 1×3 shown in (23) above can be rewritten in the form of two matrices with dimensions 9×3 in the following way, simply collecting row by row the vectors S̅₀ and S̅₁ obtained above:

$${S}_{0 \_ M} = [ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ] \\ {S}_{1 \_ M} = [ \begin{matrix}1 & 0 & 0 \\ 1 & 0 & 0 \\ 1 & 1 & 1 \\ 1 & 1 & 0 \\ 1 & 1 & 0 \\ 1 & 1 & 1 \\ 0 & 0 & 0 \\ 1 & 1 & 1 \\ 1 & 1 & 1\end{matrix} ] \qquad ( 24 )$$

These two matrices will be defined as modulation matrices for the first sector of the complex plane. A duty cycle vector D with dimension 1×9 is then defined, as follows

D=[δ₁δ₁δ₁δ₂δ₂δ₂δ₃δ₃δ₃] (25)

where it was seen that

$$\{ \begin{matrix}{δ}_{1} = \frac{{V}_{1}}{2} \frac{1}{Vb} \\ {δ}_{2} = \frac{{V}_{2}}{2} \frac{1}{Vb} \\ {δ}_{3} = \frac{1 - {δ}_{1} - {δ}_{2}}{3}\end{matrix} \qquad ( 26 )$$

It can be observed that the duty cycles to be applied to the modulator of the inverter can be calculated as row by column products between the vector D and the modulation matrices S₀_{_{—}}_{M} and S₁_{_{—}}_{M} as follows:

δ_{S}_{ₒ}=D·S₀_{_{—}}_{M} δ_{S}_{₁}=D·S₁_{_{—}}_{M} (27)

obtaining two vectors with dimensions 1×3. The first component of the vector δ_{S0} is given by the sum of the products of each of the nine components of the duty cycle vector D for the first column of the matrix S₀_{_{—}}_{M}, the second component is given by the product of each component of the vector D for each component of the second column of the matrix and the third component is given by the sum of the products of each component of the vector D for the corresponding component of the third column of the matrix. A similar definition applies to the second vector δ_{S1} with dimensions 1×3 that is obtained multiplying the vector D times the second modulation matrix.

The vector δ_{S0} contains the duty cycle values for the switches HH of the three branches A₀, A₁, A₂ of the inverter, and δ_{S1} contains the duty cycle values of the switches HL of the three branches A₀, A₁, A₂ of the inverter, as schematically indicated in FIG. 5, which represents how the values of the duty cycles described above are applied to the switches of the three-phase three-level inverter. This figure also indicates the driving signals for the switches LH and LL obtained by negation of the signals to the switches HH and HL.

What is described above for the first of the six 60-degree sectors into which the complex plane is divided can be repeated for the remaining sectors indicated with 2, 3, 4, 5, 6 in FIG. 4. The following Table 3 collects the two matrices S₀_{_{—}}_{M} and S₁_{_{—}}_{M} for each of the six sectors identified in the complex plane:

TABLE 3

| Sector | | |
|---|---|---|
| number | matrix S₀_M | matrix S₁_M |
| 1 | $[ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ]$ | $[ \begin{matrix}1 & 0 & 0 \\ 1 & 0 & 0 \\ 1 & 1 & 1 \\ 1 & 1 & 0 \\ 1 & 1 & 0 \\ 1 & 1 & 1 \\ 0 & 0 & 0 \\ 1 & 1 & 1 \\ 1 & 1 & 1\end{matrix} ]$ |
| 2 | $[ \begin{matrix}1 & 1 & 0 \\ 0 & 0 & 0 \\ 1 & 1 & 0 \\ 0 & 1 & 0 \\ 0 & 0 & 0 \\ 0 & 1 & 0 \\ 0 & 0 & 0 \\ 0 & 0 & 0 \\ 1 & 1 & 1\end{matrix} ]$ | $[ \begin{matrix}1 & 1 & 0 \\ 1 & 1 & 0 \\ 1 & 1 & 1 \\ 0 & 1 & 0 \\ 0 & 1 & 0 \\ 1 & 1 & 1 \\ 0 & 0 & 0 \\ 1 & 1 & 1 \\ 1 & 1 & 1\end{matrix} ]$ |
| 3 | $[ \begin{matrix}0 & 1 & 0 \\ 0 & 0 & 0 \\ 0 & 1 & 0 \\ 0 & 1 & 1 \\ 0 & 0 & 0 \\ 0 & 1 & 1 \\ 0 & 0 & 0 \\ 0 & 0 & 0 \\ 1 & 1 & 1\end{matrix} ]$ | $[ \begin{matrix}0 & 1 & 0 \\ 0 & 1 & 0 \\ 1 & 1 & 1 \\ 0 & 1 & 1 \\ 0 & 1 & 1 \\ 1 & 1 & 1 \\ 0 & 0 & 0 \\ 1 & 1 & 1 \\ 1 & 1 & 1\end{matrix} ]$ |
| 4 | $[ \begin{matrix}0 & 1 & 1 \\ 0 & 0 & 0 \\ 0 & 1 & 1 \\ 0 & 0 & 1 \\ 0 & 0 & 0 \\ 0 & 0 & 1 \\ 0 & 0 & 0 \\ 0 & 0 & 0 \\ 1 & 1 & 1\end{matrix} ]$ | $[ \begin{matrix}0 & 1 & 1 \\ 0 & 1 & 1 \\ 1 & 1 & 1 \\ 0 & 0 & 1 \\ 0 & 0 & 1 \\ 1 & 1 & 1 \\ 0 & 0 & 0 \\ 1 & 1 & 1 \\ 1 & 1 & 1\end{matrix} ]$ |
| 5 | $[ \begin{matrix}0 & 0 & 1 \\ 0 & 0 & 0 \\ 0 & 0 & 1 \\ 1 & 0 & 1 \\ 0 & 0 & 0 \\ 1 & 0 & 1 \\ 0 & 0 & 0 \\ 0 & 0 & 0 \\ 1 & 1 & 1\end{matrix} ]$ | $[ \begin{matrix}0 & 0 & 1 \\ 0 & 0 & 1 \\ 1 & 1 & 1 \\ 1 & 0 & 1 \\ 1 & 0 & 1 \\ 1 & 1 & 1 \\ 0 & 0 & 0 \\ 1 & 1 & 1 \\ 1 & 1 & 1\end{matrix} ]$ |
| 6 | $[ \begin{matrix}1 & 0 & 1 \\ 0 & 0 & 0 \\ 1 & 0 & 1 \\ 1 & 0 & 0 \\ 0 & 0 & 0 \\ 1 & 0 & 0 \\ 0 & 0 & 0 \\ 0 & 0 & 0 \\ 1 & 1 & 1\end{matrix} ]$ | $[ \begin{matrix}1 & 0 & 1 \\ 1 & 0 & 1 \\ 1 & 1 & 1 \\ 1 & 0 & 0 \\ 1 & 0 & 0 \\ 1 & 1 & 1 \\ 0 & 0 & 0 \\ 1 & 1 & 1 \\ 1 & 1 & 1\end{matrix} ]$ |

The twelve matrices with dimension 9×3 in Table 3 are called modulation matrices for a three-phase three-level inverter.

Ultimately, therefore, to obtain at the output of the inverter a three-phase voltage that can be represented as a rotating vector V₀ with module

$$M = \frac{{V}_{o}}{Vb} \qquad ( 28 )$$

it is sufficient to calculate for each PWM cycle the products between the vector D of the duty cycle and the two matrices with dimensions 9×3 corresponding to the sector in which the rotating vector is positioned at a given instant, determined by the electric angle α formed in that instant between the rotating vector V₀ and the vector of the sector within which lies the vector V₀ to be synthesized that is closest to the axis of the abscissa of the complex plane. Multiplying the vector of the duty cycle D, with dimension 1×9, and the two 9×3 modulation matrices corresponding to the sector in which the rotating vector is located, the duty cycle values are obtained which shall be applied to the six switches HH, HL (two for each branch) of the inverter, whilst the driving variables of the remaining six switches LH, LL are obtained as the negation of the control variables of HH and HL. A carrier-based PWM modulator receives at its input the duty cycle values and transforms them directly into on/off signals for the various switches of the various branches of the inverter, obtaining the desired three-phase voltage output.

In principle, the method according to the invention could be implemented by storing the twelve modulation matrices defined in the Table 3 in a memory support associated to the controller for driving the inverter. However, as will be clarified now, the quantity of information to be stored can in fact be far smaller, with advantages in terms of reduction of the memory employed and of the computational loads.

In fact, it is observed that the matrices of Table 3 are redundant. This redundancy can be exploited to speed up the execution of the calculation of the row times columns product. Each column of a generic 9×3 modulation matrix of Table 3 can be considered a representation of a binary number, whose least significant bit (LSB) is the one in the last position, i.e. in the ninth row, as indicated below for example for the matrix S₀_{_{—}}_{M} of the first sector

$$LSB -> [ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ] \qquad ( 29 )$$

Hence, each matrix with dimensions 9×3 corresponds to a 1×3 matrix containing three numbers in decimal notation. The S₀_{_{—}}_{M} of the first sector corresponds for example to the following 1×3 matrix:

[361,41,1] (30)

Applying this principle and then transforming each column of the twelve modulation matrices of Table 3 in corresponding matrices 1×3 of numbers in decimal notation, the following Table 4 is obtained:

TABLE 4

| Sector number | matrix R₀_M | matrix R₁_M |
|---|---|---|
| 1 | [361 41 1] | [507 123 75] |
| 2 | [321 361 1] | [459 507 75] |
| 3 | [1 361 41] | [75 507 123] |
| 4 | [1 321 361] | [75 459 507] |
| 5 | [41 1 361] | [123 75 507] |
| 6 | [361 1 321] | [507 75 459] |

These matrices constitute the modulation matrices compressed in decimal format. While the possibility of expressing the modulation matrices in decimal notation enormously simplifies the code writing and programming operations, at the end it does not influence what happens in the control system that, based on the modulation method described herein, drives the inverter.

It is now observed that in three of the six modulation matrices in decimal format R₀_{_{—}}_{M}, the same set of three numbers 361, 321, 1 is always found, and in the other three matrices R₀_{_{—}}_{M} the set of three numbers 361, 1, 41 is found. What changes is the sequence of the numbers of the set. Similar considerations hold true for the Matrices R₁_{_{—}}_{M}. To exploit this additional redundancy present in the matrices thus obtained, the following operation of rotation of a vector with dimensions 1×N is defined. Given a vector

X=[X₁X₂ . . . X_{N}] (31)

its rotation ROT(X,1) is the circular shift of the vector by one position to the right. I.e.:

ROT(X,1)=[X_{N}X₁ . . . X_{N-1}] (32)

In a similar manner, for the same vector the rotation ROT(X,−1) is defined as the circular shift of the vector by one position to the left:

ROT(X,−1)=[X₂X₃ . . . X₁] (33)

A multiple rotation by M positions (where the rotation is rightwards if M is positive and leftwards if M is negative) can be seen as a sequence of M consecutive rotations by one bit, i.e. by one position.

Having stated this, and having thus defined the operation of rotating the matrix 1×N, observing Table 4 it is noted that

$$\{ \begin{matrix}{R}_{X\_M} ( 3 ) = ROT ( {R}_{X\_M} ( 1 ) , 1 ) \\ {R}_{X\_M} ( 5 ) = ROT ( {R}_{X\_M} ( 1 ) , 2 )\end{matrix} \\ \{ \begin{matrix}{R}_{X\_M} ( 4 ) = ROT ( {R}_{X\_M} ( 2 ) , 1 ) \\ {R}_{X\_M} ( 6 ) = ROT ( {R}_{X\_M} ( 2 ) , 2 )\end{matrix} \\ where \text{:} X ∈ \{ 0 , 1 \} \qquad ( 34 )$$

This means that the third matrix R_{X}_{_{—}}_{M}(3) can be obtained from the first matrix R_{X}_{_{—}}_{M}(1) rotating by one position, whilst the fifth matrix R_{X}_{_{—}}_{M}(5) can be obtained from the first matrix rotating it by two positions. The matrix R_{X}_{_{—}}_{M}(4) and the matrix R_{X}_{_{—}}_{M}(6) are obtained rotating the second matrix R_{X}_{_{—}}_{M}(2) respectively by one and two positions.

Therefore, it is possible to define four compressed (non redundant) modulation matrices, which define the modulation of the inverter; they are defined by the matrices R₀_{_{—}}_{M}(1), R₀_{_{—}}_{M}(2), R₁_{_{—}}_{M}(1) and R₁_{_{—}}_{M}(2) with dimensions 1×3:

TABLE 5

| vector no. (X) | matrix Rₓ_M (1) | matrix Rₓ_m (2) |
|---|---|---|
| 0 | [361 41 1] | [507 123 75] |
| 1 | [321 361 1] | [459 507 75] |

From these matrices, the remaining matrices can be obtained simply by means of rotation operations as defined above. These four compressed modulation matrices can be stored in a ROM memory with the following conventional notation

$${Y}_{0 \_M} = [ \begin{matrix}{R}_{0 \_M} ( 2 ) \\ {R}_{0 \_M} ( 1 )\end{matrix} ] \\ {Y}_{1 \_M} = [ \begin{matrix}{R}_{1 \_M} ( 2 ) \\ {R}_{1 \_M} ( 1 )\end{matrix} ] \qquad ( 35 )$$

Decompressing the compressed modulation matrices with operations that are inverse to those described above (rotation and conversion from decimal to binary), the matrices of Table 3 are obtained, which, multiplied by the vector D of the duty cycles provide the two control variables of the switches HH and HL of each branch of the inverter in the six sectors into which the complex plane is divided. The control variables of the switches LH and LL are obtained as the negation of the previous ones.

The memory space required to store the data of the compressed modulation matrices for the example of the three-phase three-level modulator is 108 bit, as opposed to a space of 324 bit that would be necessary to store the same data without making recourse to rotation. This is a substantial advantage from a view point of the reduction of the memory space required for the driving of the inverter.

Moreover, the rotation operation defined above is substantially a “circular buffering” that is the simplest software technique for collecting data in digital systems. Some microprocessors have in their machine code the instructions for this rotation operation which therefore can be carried out with a single command.

The vector modulation of the inverter can use these compressed modulation matrices and, applying an inverse rotation operation, it enables to calculate for each PWM cycle the driving variables of the twelve switches of the inverter in such a way as to obtain at the output the three-phase voltage represented by the rotating vector V₀.

The organization in binary numbers is useful for the digital implementation, because the row-column product can be seen as a binary masking action rather than as a traditional product operation. The microprocessors and the DSPs usually have native instructions in their machine code to carry out binary masking. This further reduces the computational loads required to drive the inverter.

It can be demonstrated that for a three-phase L-level inverter the ROM memory space necessary to implement the method of the present invention is 6L²(L−1) bits.

### Application to the Three-Phase Two-Level Inverter

The method described above in its application to a three-phase three-level inverter can also be applied to a two-level inverter, with similar advantages. FIG. 6 schematically shows a three-phase two-level inverter, in which Vb is the bulk voltage at the terminals of the bulk capacitor indicated with 3.

In this case, the equations of the rotating vector in the complex plane are given by:

$$\begin{matrix}{V}_{α} = \frac{Vb}{2} ( {i}_{{A}_{0}} - \frac{{i}_{{A}_{1}} + {i}_{{A}_{2}}}{2} ) \\ {V}_{β} = \frac{\sqrt{3}}{2} * \frac{Vb}{2} * ( {i}_{{A}_{1}} - {i}_{{A}_{2}} )\end{matrix} \\ where \text{:} \\ {i}_{{A}_{z}} ∈ \{ 0 ; 1 \} \qquad ( 36 )$$

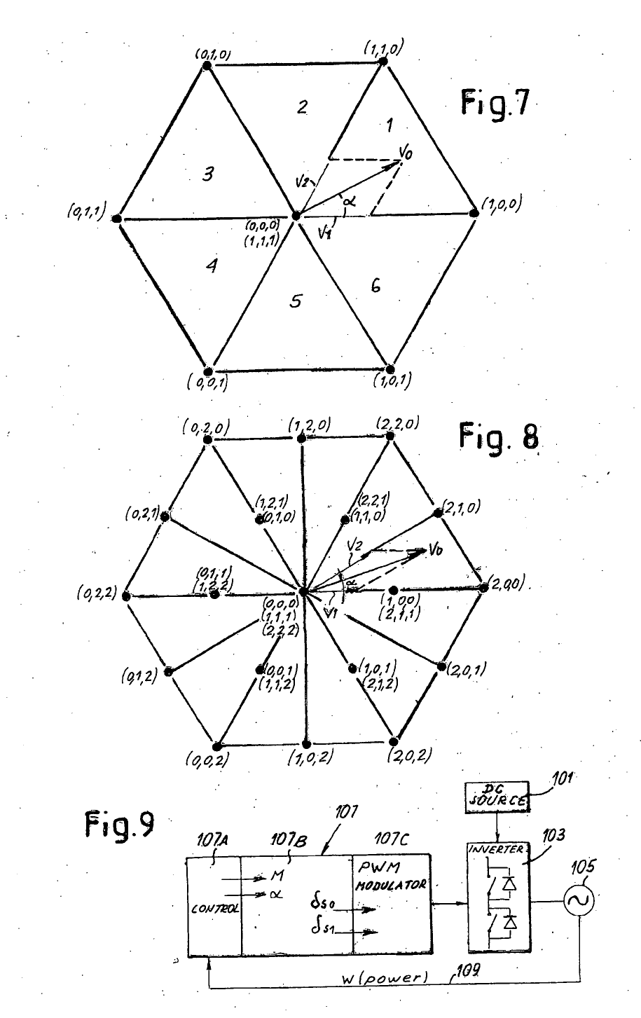

FIG. 7 shows the representation in the complex plane of the vectors that are obtained from these equations. The diagram of FIG. 7 corresponds (in the case of three-phase two-level inverters) to the diagram of FIG. 2 for the three-phase three-level inverter. The number of vectors is smaller and equal to eight. Therefore, in this case the algorithm can be implemented using all vectors. The duty cycle vector is given by

D=[δ₁δ₂δ₃] (37)

where, as can be demonstrated in a manner similar to the one employed for the case of the three-level inverter, the following is obtained

$$\{ \begin{matrix}{δ}_{1} = \frac{{V}_{1}}{Vb} \\ {δ}_{2} = \frac{{V}_{2}}{Vb} \\ {δ}_{3} = \frac{1 - {δ}_{1} - {δ}_{2}}{2}\end{matrix} \qquad ( 38 )$$

For each branch of the three-phase inverter, a single control variable is necessary for driving the switch HH, whilst the driving signal of the switch LL is given by the negation of the control variable of the switch HH. The relationship between control variable and state of the phase considered is summarized by the following Table 6:

TABLE 6

| State number for the generic phase Aₓ | Variable S₀_x |
|---|---|
| 0 | 0 |
| 1 | 1 |

In this case, the modulation matrices will be just one matrix, for each branch, since one control variable is sufficient for each branch of the inverter. Hence, there will be the following six modulation matrices for the six sectors of 60 electric degrees, into which the complex plane was divided (sectors once again indicated with the numbers 1 through 6 in FIG. 7):

TABLE 7

| Sector no. | Matrix S₀_M |
|---|---|
| 1 | $[ \begin{matrix}1 & 0 & 0 \\ 1 & 1 & 0 \\ 0 & 0 & 0 \\ 1 & 1 & 1\end{matrix} ]$ |
| 2 | $[ \begin{matrix}1 & 1 & 0 \\ 0 & 1 & 0 \\ 0 & 0 & 0 \\ 1 & 1 & 1\end{matrix} ]$ |
| 3 | $[ \begin{matrix}0 & 1 & 0 \\ 0 & 1 & 1 \\ 0 & 0 & 0 \\ 1 & 1 & 1\end{matrix} ]$ |
| 4 | $[ \begin{matrix}0 & 1 & 1 \\ 0 & 0 & 1 \\ 0 & 0 & 0 \\ 1 & 1 & 1\end{matrix} ]$ |
| 5 | $[ \begin{matrix}0 & 0 & 1 \\ 1 & 0 & 1 \\ 0 & 0 & 0 \\ 1 & 1 & 1\end{matrix} ]$ |
| 6 | $[ \begin{matrix}1 & 0 & 1 \\ 1 & 0 & 0 \\ 0 & 0 & 0 \\ 1 & 1 & 1\end{matrix} ]$ |

The binary compression of the matrices of Table 7 leads to the following six 1×3 matrices:

TABLE 8

| Sector number | Matrix R₀_M |
|---|---|
| 1 | [13 5 1] |
| 2 | [9 13 1] |
| 3 | [1 13 5] |
| 4 | [1 9 13] |
| 5 | [5 1 13] |
| 6 | [13 1 9] |

Using the ROT operator defined above, it is clear that the following compressed modulation matrices R₀_{_{—}}_{M}(1) and R₀_{_{—}}_{M}(2)

| Vector no. (X) | Matrix R₀_M |
|---|---|
| 0 | [13 5 1] |
| 1 | [9 13 1] |

are sufficient to implement the rows by columns product. These matrices can be stored in a ROM memory occupying only 24 bits and using the following conventional notation:

$${Y}_{0 \_M} = [ \begin{matrix}{R}_{0 \_M} ( 2 ) \\ {R}_{0 \_M} ( 1 )\end{matrix} ] \qquad ( 39 )$$

This demonstrates that the method according to the invention can be utilized with advantages in terms of computational loads also in a two-level inverter, typically used for example to control small electrical tools or electrical appliances.

Application to Inverters with Four and Five Voltage Levels

Based on computations similar to those described above, the compressed modulation matrices for a number of levels L different from 2 and 3 can be obtained. The mathematical demonstration is omitted for the sake of brevity. In the case of a four-level inverter (L=4), the modulation matrices in compressed form are shown in Table 9 below:

TABLE 9

| Vector no. (X) | matrix R_{X}_M (1) | matrix R_{X}_M (2) |
|---|---|---|
| 0 | [42641 657 1] | [41985 42641 1] |
| 1 | [61363 1971 1043] | [60435 61363 1043] |
| 2 | [65527 12279 11447] | [64695 65527 11447] |

The matrices can be stored in 288 bits (36 bytes) of memory with the conventional notation

$${Y}_{0 \_M} = [ \begin{matrix}{R}_{0 \_M} ( 2 ) \\ {R}_{0 \_M} ( 1 )\end{matrix} ] \\ {Y}_{1 \_M} = [ \begin{matrix}{R}_{1 \_M} ( 2 ) \\ {R}_{1 \_M} ( 1 )\end{matrix} ] \\ {Y}_{2 \_M} = [ \begin{matrix}{R}_{2 \_M} ( 2 ) \\ {R}_{2 \_M} ( 1 )\end{matrix} ] \qquad ( 40 )$$

In the case of a five-level inverter (L=5), the following is obtained:

TABLE 10

| Vec- | | |
|---|---|---|
| tor | | |
| no. | | |
| (X) | matrix R_{X}_M (1) | matrix R_{X}_M (2) |
| 0 | [21549601 21025 1] | [21528577 21549601 1] |
| 1 | [31061603 63075 32803] | [31031331 31061603 32803] |
| 2 | [33292007 655079 623207] | [33260135 33292007 623207] |
| 3 | [33554415 6029295 6002415] | [33527535 33554415 6002415] |

$${Y}_{0 \_M} = [ \begin{matrix}{R}_{0 \_M} ( 2 ) \\ {R}_{0 \_M} ( 1 )\end{matrix} ] \\ {Y}_{1 \_M} = [ \begin{matrix}{R}_{1 \_M} ( 2 ) \\ {R}_{1 \_M} ( 1 )\end{matrix} ] \\ {Y}_{2 \_M} = [ \begin{matrix}{R}_{2 \_M} ( 2 ) \\ {R}_{2 \_M} ( 1 )\end{matrix} ] \\ {Y}_{3 \_M} = [ \begin{matrix}{R}_{3 \_M} ( 2 ) \\ {R}_{3 \_M} ( 1 )\end{matrix} ] \qquad ( 41 )$$

In this case, the compressed modulation matrices occupy 600 bits (75 bytes).
Application of the Method to the Driving of a Three-Phase Inverter with L Levels

Having defined the duty cycle vector and the modulation matrices as well as the compressed modulation matrices as illustrated above, the way the control algorithm of the driving of the inverter operates will now be clarified. This algorithm can advantageously be implemented on processors in which the following elementary instructions are available:

AND=bit by bit “AND” instruction
ADD/MPY/SHIFT/MAC=arithmetical addition, multiplication, translation and multiplication-accumulation
ROT=clockwise binary rotation

The steps of the method can be summarized as follows:

The first step consists of expressing in polar coordinates the rotating vector V₀ that represents the three-phase voltage of the inverter.

Substantially, having to drive the three-phase inverter in such a way as to obtain a three-phase voltage output represented by a set of three balanced rotating voltages, first of all these voltages are represented as a single rotating vector V₀ in the complex plane. The rotating vector V₀ is defined by:

V₀=Me^{jα} in which:

$$\begin{matrix}0 \leq M = \frac{{V}_{0}}{Vb} \leq \frac{\sqrt{3}}{2} & 0 \leq α \leq 2 π\end{matrix} \qquad ( 42 )$$

where M is the modulation index associated to the rotating vector V₀. The angle α is the electric angle between the rotating vector and the real axis of the complex plane, j is the imaginary unit.

At each PWM cycle, it is necessary to determine the sector of the complex plane in which the rotating vector V₀ is instantaneously located and the value of the modified phase angle, hereafter indicated as α̅.

For this purpose, various methods can be used. In advantageous embodiments of the invention, the phase angle α is divided by the dimension of a sector. Since the complex plane is divided into six sectors, each sector will have an amplitude of 60°, i.e. π/3 radiants. To determine in which sector the rotating vector V₀ representative of the voltage to be obtained at the output of the three-phase inverter is instantaneously located, it is sufficient to divide the value of the phase angle α by π/3 and to compare the value obtained with the six values indicated in the left column of the following Table 11:

TABLE 11

| | Number of the |
|---|---|
| α_sector | sector (P) |
| π/3 | 1 |
| 2π/3 | 2 |
| π | 3 |
| 4π/3 | 4 |
| 5π/3 | 5 |
| 2π | 6 |

The sector in which the rotating vector is located is given by the row corresponding to the first value of α_sector for which

α≦α_sector (43)

For example, if the angle is 30° (π/6), then the sector P in which the vector V₀ is located is the sector P=1, since (π/6)<π/3.

Having identified the number P of the sector in which the rotating vector V₀ is located instantaneously, the modified phase angle α̅ to be considered in the subsequent calculation of the duty cycle vector (vector D) is defined as:

$$\overline{α} = α - \frac{π}{3} ( P - 1 ) \qquad ( 44 )$$

Essentially, the modified phase angle is obtained by offsetting the phase of the vector until this vector, and the entire sector in which it lies, is brought back to a geometric condition similar to the one of the first sector. Based on the modified phase angle, the three values of the duty cycle are calculated as

$${δ}_{1} = \frac{M}{2 * ( L - 1 )} * ( \sqrt{3} cos \overline{α} - sin \overline{α} ) \\ {δ}_{2} = \frac{M}{L - 1} * sin \overline{α} \\ {δ}_{3} = \frac{1 - {δ}_{1} - {δ}_{2}}{L} \qquad ( 45 )$$

where L is the number of levels of the inverter. In the case of three-level inverters (L=3), the three values of the duty cycle are those obtained in the expressions in the formulas (21), i.e.

$${δ}_{1} = \frac{M}{4} * ( \sqrt{3} cos \overline{α} - sin \overline{α} ) \\ {δ}_{2} = \frac{M}{2} * sin \overline{α} \\ {δ}_{3} = \frac{1 - {δ}_{1} - {δ}_{2}}{3} \qquad ( 46 )$$

The duty cycle vector D is hence given by:

$$D = [ \begin{matrix}{\underbrace{\begin{matrix}{δ}_{1} & {δ}_{1} & … & {δ}_{1}\end{matrix}}}_{L \frac{L - 1}{2} elements} & {\underbrace{\begin{matrix}{δ}_{2} & {δ}_{2} & … & {δ}_{2}\end{matrix}}}_{L \frac{L - 1}{2} elements} & {\underbrace{\begin{matrix}{δ}_{3} & {δ}_{3} & … & {δ}_{3}\end{matrix}}}_{L elements}\end{matrix} ] \qquad ( 47 )$$

which in the case of three-level inverters (L=3) leads to:

D=[δ₁,δ₁,δ₁,δ₂δ₂δ₂δ₃δ₃δ₃] (48)

Since, as seen above, the variables for the driving of the switches of the inverter are obtained by the matrix multiplication of the duty cycle vector by the corresponding modulation matrices of the relevant sector, in turn obtained by an inverse operation with respect to the operation whereby the compressed modulation matrices were obtained, the next step of the driving algorithm consists of the selection of the compressed modulation matrices corresponding to the sector in which the rotating vector is located and subsequently of the expansion of the compressed modulation matrices to obtain the modulation matrices that, multiplied by the duty cycle vector D, yield the driving variables.

The compressed modulation matrices are L−1 matrices from R₀_{_{—}}_{M}, to R_{L-2}_{_{—}}_{M} collected in (L−1) groups Y₀_{_{—}}_{M} to Y_{L-2}_{_{—}}_{M}. As seen in the previous discussion, in the case of three-level inverters (L=3), the compressed matrices are obtained from (see formula 35):

$${Y}_{0 \_M} = [ \begin{matrix}{R}_{0 \_M} ( 2 ) \\ {R}_{0 \_M} ( 1 )\end{matrix} ]$$

$${Y}_{1 \_M} = [ \begin{matrix}{R}_{1 \_M} ( 2 ) \\ {R}_{1 \_M} ( 1 )\end{matrix} ]$$

In the case of four ad five-level inverters, the matrices are obtained from the formulas (40) and (41):

$${Y}_{0 \_M} = [ \begin{matrix}{R}_{0 \_M} ( 2 ) \\ {R}_{0 \_M} ( 1 )\end{matrix} ]$$

$${Y}_{1 \_M} = [ \begin{matrix}{R}_{1 \_M} ( 2 ) \\ {R}_{1 \_M} ( 1 )\end{matrix} ]$$

$${Y}_{2 \_M} = [ \begin{matrix}{R}_{2 \_M} ( 2 ) \\ {R}_{2 \_M} ( 1 )\end{matrix} ]$$

$$and$$

$${Y}_{0 \_M} = [ \begin{matrix}{R}_{0 \_M} ( 2 ) \\ {R}_{0 \_M} ( 1 )\end{matrix} ]$$

$${Y}_{1 \_M} = [ \begin{matrix}{R}_{1 \_M} ( 2 ) \\ {R}_{1 \_M} ( 1 )\end{matrix} ]$$

$${Y}_{2 \_M} = [ \begin{matrix}{R}_{2 \_M} ( 2 ) \\ {R}_{2 \_M} ( 1 )\end{matrix} ]$$

$${Y}_{3 \_M} = [ \begin{matrix}{R}_{3 \_M} ( 2 ) \\ {R}_{3 \_M} ( 1 )\end{matrix} ]$$

and the numeric values are indicated respectively in the Tables 8 and 9.

Through the application of the rotation, for each branch of the inverter the modulation matrices are obtained, which need to be multiplied by the duty cycle vector. The operations that convert the compressed modulation matrices in the non-compressed modulation matrices are the following:

$${R}_{0 \_ M} = ROT \{ \begin{matrix}{Y}_{0 \_ M} [ P - ( P >>> 1 ) << 1 ] , \\ P - 1 + ( P >> 1 ) + ( P >> 1 ) << 1\end{matrix} \} \\ … \\ … \\ {R}_{L - 2 \_ M} = ROT \{ \begin{matrix}{Y}_{L - 2 \_ M} [ P - ( P >> 1 ) << 1 ] , \\ P - 1 + ( P >> 1 ) + ( P >> 1 ) << 1\end{matrix} \} \qquad ( 49 )$$

In the above equations, P indicates the sector in which the rotating vector V₀ is located according to Table 11, and according to a conventional notation the symbol “<<” indicates a rotation (shift) by one bit to the right, whilst the symbol “>>” indicates a rotation (shift) by one bit to the left.

The operations required to obtain the indices of the expanded modulation matrices are then simple rightwards or leftwards shift and addition or subtraction operations. All these operations are native in microprocessors and in DSPs and hence the entire process of retrieval of the modulation matrices can be executed in very short calculation times. This enables to drive even inverters with many levels, storing a limited number of data, retrieving the modulation matrices from the stored data with calculations that can be carried out in very short times.

Once the modulation matrices are obtained from the compressed modulation matrices, the values of the duty cycles are obtained executing the row by column product in binary form between the duty cycle vector and the modulation matrices in binary form. This multiplication operation is expressed as

$${δ}_{{S}_{0}} = D ⊗ {R}_{0 \_M} \\ {δ}_{{S}_{1}} = D ⊗ {R}_{1 \_M} \\ … \\ … \\ {δ}_{{S}_{L - 2}} = D ⊗ {R}_{L - 2 \_M} \qquad ( 50 )$$

Since L is the number of levels of the inverter, the vector D is a vector with 1×L² dimensions, whilst the modulation matrices are substantially constituted by vectors with dimension 1×3, where each element is in turn constituted by a column of L² binary digits (1, 0). For example, in the case of three-level inverters (L=3) it has been seen that the modulation matrices are those shown in Table 3.

The matrix multiplication between a vector K, comprising one row of L² elements, and a matrix J, comprising 3×L² elements, defined as follows:

K=(K₁K₂K₃ . . . K_{L}_{²}) where: KₓεR⁺

J=(J₁J₂J₃) where: Jₓ=Jₓ_{_{—}}₁Jₓ_{_{—}}₂Jₓ_{_{—}}₃ . . . Jₓ_{_{—}}_{L}² (51)

is defined by

W=(W₀W₂W₃)=K\textcircled{x}J (52)

where each element W_{z} is given by

$${W}_{z} = {{MAC}^{{L}^{2}}}_{i = 1} ( {K}_{i} * {J}_{z \_ i} ) \qquad ( 53 )$$

in which the operator MAC is represented by the “multiply and accumulate” operator, which constitutes one of the elementary instructions of the microprocessor or of the DSP on which the inverter driving algorithm is run.

Therefore, the driving signals of the switches of the various levels in the individual branches of the inverter are obtained with a matrix multiplication of the duty cycle vector D and of the modulation matrices, with minimal calculation times, given the native nature of the instruction used.

The quantities,

(δ_{S}_{₀},δ_{S}_{₁}, . . . ,δ_{S}_{_{L-2}}) (54)

obtained from the aforesaid multiplication represent the duty cycle variables for the switches of the upper part of each branch of the inverter, i.e. in the case of three-level inverters (FIG. 1B), the switches HH and HL, where expression (53) is reduced to

(δ_{S}_{₀},δ_{S}_{₁}) (55)

The values thus calculated are loaded as duty cycle variables in a modulator of a microcontroller that drives the inverter. The output of the modulator, on the basis of the duty cycles thus calculated, constitutes the on/off driving signal of the switches of the upper part and, through a negation operation, the driving signals of the corresponding switches in the lower part are obtained.

Implementation with Three-Phase Three-Level Inverters Using all State Vectors

All the embodiments of the vector modulation method described so far are based on the use of a lower number of state vectors than the total number of vectors that, in a complex plane, represent all the possible states of the inverters. In fact, whilst FIG. 2 shows all 27 state vectors, in FIG. 3 four of these vectors were eliminated, and specifically those defined by the state triplets (2,1,0), (0,2,1), (0,1,2) and (2,0,1). This has enabled substantially to simplify the calculation algorithm, because the complex plane was subdivided only into six sectors, of 60 degrees each. The simplification, that reduces calculation loads and the memory space required to store the data, is substantially irrelevant for the purposes of the result obtained, because the number of state vectors used is still sufficient to obtain an output wave form with a very low harmonic content. The use of the four omitted state vectors, whilst possible from a theoretical viewpoint, in fact does not entail an appreciable advantage in the practical embodiments of the inverter in terms of harmonic content of the wave form of the voltage output from the inverter.

However, for the sake of a complete disclosure of the present invention, a description will be provided below of the manner in which the method can also be implemented using all 27 state vectors that define the possible conditions of the three-phase three-level inverter of FIG. 1B.

FIG. 8 shows the 27 state vectors in the complex plane, as well as twelve sectors of 30 degrees each, into which the complex plane is subdivided considering the rays on which these vectors lie. In the same FIG. 8, a generic rotating vector V₀ is indicated in the first of the aforesaid twelve sectors. The vector V₀ forms an angle α with the real axis of the complex plane. The references V₁ and V₂ indicate the projections of the vector V₀ on rays defining the sector in which the vector V₀ is located instantaneously, i.e. the real axis and the ray inclined by 30° relative to this real axis.

In a manner similar to what is described in the simplified example with a subdivision of the complex plane into only six sectors, in this case as well the vector V₀ can be synthesized using the same linear combination already employed obtaining the equation (18) of the vectors (2,0,0), (1,0,0) and (2,1,1) to synthesize the component V₁, whilst the vector V₂ is synthesized using only the vector (2,1,0). For the vector V₁, similarly to what has already been seen above, the following is obtained:

$$( 2 , 0 , 0 ) -> {δ}_{1}^{1} = \frac{{V}_{1}}{2} \frac{1}{Vb} \\ ( 1 , 0 , 0 ) -> {δ}_{1}^{2} = \frac{{V}_{1}}{4} \frac{1}{Vb / 2} = \frac{{V}_{1}}{2} \frac{1}{Vb} \\ ( 2 , 1 , 1 ) -> {δ}_{1}^{3} = \frac{{V}_{1}}{4} \frac{1}{Vb / 2} = \frac{{V}_{1}}{2} \frac{1}{Vb} \qquad ( 56 )$$

The three mutually equal duty cycles will be indicated with δ₁.

The duty cycle for the vector V₂ is given by:

$$( 2 , 1 , 0 ) -> {δ}_{2}^{1} = \frac{{V}_{2}}{\frac{\sqrt{3}}{2}} \frac{1}{Vb} = \frac{2}{\sqrt{3}} \frac{{V}_{2}}{Vb} \qquad ( 57 )$$

This duty cycle can be expressed as:

$${δ}_{2}^{1} = \frac{4}{\sqrt{3}} {δ}_{2} \qquad ( 58 )$$

To assure the physical coherence of the vector, the remaining part (if existing) of the PWM cycle must be attributed to the zero vectors. This leads to express a third duty cycle as follows:

$${δ}_{3} = \frac{1 - {δ}_{1} - \frac{4}{\sqrt{3}} {δ}_{2}}{3} \qquad ( 59 )$$

Ultimately, the duty cycle vector, still indicated with D, in this case is given by:

$$D = [ \begin{matrix}{δ}_{1} & {δ}_{1} & {δ}_{1} & \frac{4}{\sqrt{3}} {δ}_{2} & {δ}_{3} & {δ}_{3} & {δ}_{3}\end{matrix} ] \qquad ( 60 )$$

The modulation matrices associated to the first sector are given by:

$$\begin{matrix}{S}_{0 \_ M} = [ \begin{matrix}1 & 0 & 0 \\ 0 & 0 & 0 \\ 1 & 0 & 0 \\ 1 & 0 & 0 \\ 0 & 0 & 0 \\ 0 & 0 & 0 \\ 1 & 1 & 1\end{matrix} ] & ( 61 ) \\ {S}_{1 \_ M} = [ \begin{matrix}1 & 0 & 0 \\ 1 & 0 & 0 \\ 1 & 1 & 1 \\ 1 & 1 & 0 \\ 0 & 0 & 0 \\ 1 & 1 & 1 \\ 1 & 1 & 1\end{matrix} ] & \end{matrix}$$

from which:

δ_{S}_{₀}=D·S₀_{_{—}}_{M} δ_{S}_{₁}=D·S₁_{_{—}}_{M} (62)

If the rotating vector is positioned in the second sector (between 30 and 60 degrees) of the complex plane of FIG. 8, it can be readily observed that the component V₁ on the ray forming an angle of 30° with the real axis is given by the vector (2,1,0) with a duty cycle equal to

$$( 2 , 1 , 0 ) -> {δ}_{1}^{1} = \frac{{V}_{1}}{\frac{\sqrt{3}}{2}} \frac{1}{Vb} = \frac{2}{\sqrt{3}} \frac{{V}_{1}}{Vb} = \frac{4}{\sqrt{3}} {δ}_{1} \qquad ( 63 )$$

The component V₂ is obtained by linearly combining the state vector (2,2,0), (1,1,0) and (2,2,1) obtaining the duty cycles δ₂. The combination of the null vectors with a duty cycle equal to

$${δ}_{3} = \frac{1 - \frac{4}{\sqrt{3}} {δ}_{1} - {δ}_{2}}{3} \qquad ( 64 )$$

covers the remaining portion, if any, of the PWM cycle. Consequently, the duty cycle vector is given by:

$$D = [ \begin{matrix}\frac{4}{\sqrt{3}} {δ}_{1} & {δ}_{2} & {δ}_{2} & {δ}_{2} & {δ}_{3} & {δ}_{3} & {δ}_{3}\end{matrix} ] \qquad ( 65 )$$

Therefore, the duty cycle vector will be defined differently depending on the sector in which the rotating vector is positioned. More exactly, the duty cycle vector D will be given by:

$$D = \{ \begin{matrix}[ \begin{matrix}\frac{4}{\sqrt{3}} * {δ}_{1} & {δ}_{2} & {δ}_{2} & {δ}_{2} & {δ}_{3} & {δ}_{3} & {δ}_{3}\end{matrix} ] if the vector is in an even sector \\ [ \begin{matrix}{δ}_{1} & {δ}_{1} & {δ}_{1} & \frac{4}{\sqrt{3}} * {δ}_{2} & {δ}_{3} & {δ}_{3} & {δ}_{3}\end{matrix} ] if the vector is in an odd sector\end{matrix} \qquad ( 66 )$$

Proceeding similarly to what has already been described with reference to the embodiment in which only the state vectors shown in FIG. 3 are used, two modulation matrices can be defined for each of the twelve sectors into which the complex plane is divided. These matrices are shown in Table 12 below

TABLE 12

| Sector | | |
|---|---|---|
| number | Matrix S₀_M | Matrix S₁_ M |
| 1 | $[ \begin{matrix}1 & 0 & 0 \\ 0 & 0 & 0 \\ 1 & 0 & 0 \\ 1 & 0 & 0 \\ 0 & 0 & 0 \\ 0 & 0 & 0 \\ 1 & 1 & 1\end{matrix} ]$ | $[ \begin{matrix}1 & 0 & 0 \\ 1 & 0 & 0 \\ 1 & 1 & 1 \\ 1 & 1 & 0 \\ 0 & 0 & 0 \\ 1 & 1 & 1 \\ 1 & 1 & 1\end{matrix} ]$ |
| 2 | $[ \begin{matrix}1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ]$ | $[ \begin{matrix}1 & 1 & 0 \\ 1 & 1 & 0 \\ 1 & 1 & 0 \\ 1 & 1 & 1 \\ 0 & 0 & 0 \\ 1 & 1 & 1 \\ 1 & 1 & 1\end{matrix} ]$ |
| 3 | $[ \begin{matrix}1 & 1 & 0 \\ 0 & 0 & 0 \\ 1 & 1 & 0 \\ 0 & 1 & 0 \\ 0 & 0 & 0 \\ 0 & 0 & 0 \\ 1 & 1 & 1\end{matrix} ]$ | $[ \begin{matrix}1 & 1 & 0 \\ 1 & 1 & 0 \\ 1 & 1 & 1 \\ 1 & 1 & 0 \\ 0 & 0 & 0 \\ 1 & 1 & 1 \\ 1 & 1 & 1\end{matrix} ]$ |
| 4 | $[ \begin{matrix}0 & 1 & 0 \\ 0 & 1 & 0 \\ 0 & 0 & 0 \\ 0 & 1 & 0 \\ 0 & 0 & 0 \\ 0 & 0 & 0 \\ 1 & 1 & 1\end{matrix} ]$ | $[ \begin{matrix}1 & 1 & 0 \\ 0 & 1 & 0 \\ 0 & 1 & 0 \\ 1 & 1 & 1 \\ 0 & 0 & 0 \\ 1 & 1 & 1 \\ 1 & 1 & 1\end{matrix} ]$ |
| 5 | $[ \begin{matrix}0 & 1 & 0 \\ 0 & 0 & 0 \\ 0 & 1 & 0 \\ 0 & 1 & 0 \\ 0 & 0 & 0 \\ 0 & 0 & 0 \\ 1 & 1 & 1\end{matrix} ]$ | $[ \begin{matrix}0 & 1 & 0 \\ 0 & 1 & 0 \\ 1 & 1 & 1 \\ 0 & 1 & 1 \\ 0 & 0 & 0 \\ 1 & 1 & 1 \\ 1 & 1 & 1\end{matrix} ]$ |
| 6 | $[ \begin{matrix}0 & 1 & 0 \\ 0 & 1 & 1 \\ 0 & 0 & 0 \\ 0 & 1 & 1 \\ 0 & 0 & 0 \\ 0 & 0 & 0 \\ 1 & 1 & 1\end{matrix} ]$ | $[ \begin{matrix}0 & 1 & 1 \\ 0 & 1 & 1 \\ 0 & 1 & 1 \\ 1 & 1 & 1 \\ 0 & 0 & 0 \\ 1 & 1 & 1 \\ 1 & 1 & 1\end{matrix} ]$ |
| 7 | $[ \begin{matrix}0 & 1 & 1 \\ 0 & 0 & 0 \\ 0 & 1 & 1 \\ 0 & 0 & 1 \\ 0 & 0 & 0 \\ 0 & 0 & 0 \\ 1 & 1 & 1\end{matrix} ]$ | $[ \begin{matrix}0 & 1 & 1 \\ 0 & 1 & 1 \\ 1 & 1 & 1 \\ 0 & 1 & 1 \\ 0 & 0 & 0 \\ 1 & 1 & 1 \\ 1 & 1 & 1\end{matrix} ]$ |
| 8 | $[ \begin{matrix}0 & 0 & 1 \\ 0 & 0 & 1 \\ 0 & 0 & 0 \\ 0 & 0 & 1 \\ 0 & 0 & 0 \\ 0 & 0 & 0 \\ 1 & 1 & 1\end{matrix} ]$ | $[ \begin{matrix}0 & 1 & 1 \\ 0 & 0 & 1 \\ 0 & 0 & 1 \\ 1 & 1 & 1 \\ 0 & 0 & 0 \\ 1 & 1 & 1 \\ 1 & 1 & 1\end{matrix} ]$ |
| 9 | $[ \begin{matrix}0 & 0 & 1 \\ 0 & 0 & 0 \\ 0 & 0 & 1 \\ 0 & 0 & 1 \\ 0 & 0 & 0 \\ 0 & 0 & 0 \\ 1 & 1 & 1\end{matrix} ]$ | $[ \begin{matrix}0 & 0 & 1 \\ 0 & 0 & 1 \\ 1 & 1 & 1 \\ 1 & 0 & 1 \\ 0 & 0 & 0 \\ 1 & 1 & 1 \\ 1 & 1 & 1\end{matrix} ]$ |
| 10 | $[ \begin{matrix}0 & 0 & 1 \\ 1 & 0 & 1 \\ 0 & 0 & 0 \\ 1 & 0 & 1 \\ 0 & 0 & 0 \\ 0 & 0 & 0 \\ 1 & 1 & 1\end{matrix} ]$ | $[ \begin{matrix}1 & 0 & 1 \\ 1 & 0 & 1 \\ 1 & 0 & 1 \\ 1 & 1 & 1 \\ 0 & 0 & 0 \\ 1 & 1 & 1 \\ 1 & 1 & 1\end{matrix} ]$ |
| 11 | $[ \begin{matrix}1 & 0 & 1 \\ 0 & 0 & 0 \\ 1 & 0 & 1 \\ 1 & 0 & 0 \\ 0 & 0 & 0 \\ 0 & 0 & 0 \\ 1 & 1 & 1\end{matrix} ]$ | $[ \begin{matrix}1 & 0 & 1 \\ 1 & 0 & 1 \\ 1 & 1 & 1 \\ 1 & 0 & 1 \\ 0 & 0 & 0 \\ 1 & 1 & 1 \\ 1 & 1 & 1\end{matrix} ]$ |
| 12 | $[ \begin{matrix}1 & 0 & 0 \\ 1 & 0 & 0 \\ 0 & 0 & 0 \\ 1 & 0 & 0 \\ 0 & 0 & 0 \\ 0 & 0 & 0 \\ 1 & 1 & 1\end{matrix} ]$ | $[ \begin{matrix}1 & 0 & 1 \\ 1 & 0 & 0 \\ 1 & 0 & 0 \\ 1 & 1 & 1 \\ 0 & 0 & 0 \\ 1 & 1 & 1 \\ 1 & 1 & 1\end{matrix} ]$ |

These matrices can be expressed in compressed form as 1×3 matrices of numbers in decimal notation as indicated in Table 13 below:

TABLE 13

| Sector no. | Matrix R₀_M | Matrix R₁_M |
|---|---|---|
| 1 | [89 1 1] | [123 27 19] |
| 2 | [105 41 1] | [123 123 11] |
| 3 | [81 89 1] | [123 123 19] |
| 4 | [1 105 1] | [75 123 11] |
| 5 | [1 89 1] | [19 123 27] |
| 6 | [1 105 41] | [11 123 123] |
| 7 | [1 81 89] | [19 123 123] |
| 8 | [1 1 105] | [11 75 123] |
| 9 | [1 1 89] | [27 19 123] |
| 10 | [41 1 105] | [123 11 123] |
| 11 | [89 1 81] | [123 19 123] |
| 12 | [105 1 1] | [123 11 75] |

As can be observed, in this case too there is a redundancy of data, so that the matrices of Table 13 can be compressed using the rotation and obtaining two compressed matrices

$${Y}_{0 \_ M} = [ \begin{matrix}{R}_{0 \_ M} ( 4 ) \\ {R}_{0 \_ M} ( 3 ) \\ {R}_{0 \_ M} ( 2 ) \\ {R}_{0 \_ M} ( 1 )\end{matrix} ] \\ {Y}_{1 \_ M} = [ \begin{matrix}{R}_{1 \_ M} ( 4 ) \\ {R}_{1 \_ M} ( 3 ) \\ {R}_{1 \_ M} ( 2 ) \\ {R}_{1 \_ M} ( 1 )\end{matrix} ] \qquad ( 67 )$$

from which the remaining matrices can be obtained by inverse rotation as follows:

$$\{ \begin{matrix}{R}_{X \_ M} ( 5 ) = ROT ( {R}_{X \_ M} ( 1 ) , 1 ) \\ {R}_{X \_ M} ( 9 ) = ROT ( {R}_{X \_ M} ( 1 ) , 2 )\end{matrix} \\ \{ \begin{matrix}{R}_{X \_ M} ( 6 ) = ROT ( {R}_{X \_ M} ( 2 ) , 2 ) \\ {R}_{X \_ M} ( 10 ) = ROT ( {R}_{X \_ M} ( 2 ) , 2 )\end{matrix} \\ \{ \begin{matrix}{R}_{X \_ M} ( 7 ) = ROT ( {R}_{X \_ M} ( 3 ) , 1 ) \\ {R}_{X \_ M} ( 11 ) = ROT ( {R}_{X \_ M} ( 3 ) , 2 )\end{matrix} \\ \{ \begin{matrix}{R}_{X \_ M} ( 8 ) = ROT ( {R}_{X \_ M} ( 4 ) , 1 ) \\ {R}_{X \_ M} ( 12 ) = ROT ( {R}_{X \_ M} ( 4 ) , 2 )\end{matrix} \qquad ( 68 )$$

where Xε{0;1}

The total memory space for the storage of these matrices in compressed version is 21 bytes.

FIG. 9 shows a diagram of a possible application of the modulation method for driving a three-phase inverter for the conditioning of the electric energy generated by a DC source. In some embodiments, the DC source can be a renewable source. In some embodiments, the DC source can be a photovoltaic panel or a field of photovoltaic panels. In the diagram of FIG. 9, the DC source is schematically indicated with 101. It is connected to the input of a generic inverter 103, which can be for example a three-phase inverter with two or three levels, or even with a higher number of levels. The output of the inverter can be connected to a load, or to an electric grid. In the example illustrated in FIG. 9, the reference number 105 schematically indicates a three-phase electric distribution grid. Typically, in some embodiments it is necessary to control the inverter 103 in such a way that it injects a determined power on the electric grid 105. The reference W (power) indicates a power feedback signal. The control and drive system (generically indicated with the reference 107) of the inverter 103 comprises a controller 107A which, on the basis of the signal W, calculates the modulation index M and the electric angle α of the rotating vector V₀ that represents the three-phase voltage that is required at the output from the inverter 103 to supply on the grid 105 the required power, defined by the signal W. From the values of the modulation index and of the electric angle, the control and drive system calculates the duty cycle vector. Through the multiplication of the duty cycle vector and the modulation matrices, stored in the control system 107, the duty cycles are calculated which, supplied to the PWM modular, enable to generate the physical signals for driving the electronic switches of the inverter.

In the embodiments of the invention described above, reference is made to a voltage controlled inverter. On the basis of the same concept described above, a method for modulating a current controlled inverter can be implemented.

1-19. (canceled)

20. A method of modulating a multiphase inverter wherein the inverter comprises a pulse width modulation (PWM) modulator and plurality of electronic inverter switches, the method comprising:
calculating a duty cycle vector as a function of electric parameters defining a rotating vector representative of an output electric quantity required from the inverter;
multiplying the duty cycle vector by a stored modulation matrix to obtain a plurality of duty cycle signals for the plurality of electronic switches of said inverter; and
driving the inverter switches as a function of the duty cycle signals.

21. The method of claim 20, wherein said duty cycle vector is multiplied by a number of modulation matrices determined by a number of voltage levels of said inverter.

22. The method of claim 20, further comprising:
storing data defining a plurality of modulation matrices;
for each PWM cycle in said inverter, determining a modulation index and a phase angle of a rotating vector representative of an output electric quantity required from the inverter;
determining a sector of a complex plane said rotating vector is located;
calculating the duty cycle vector based on the phase angle and on a modulus of said rotating vector;
executing a matrix multiplication between the duty cycle vector and at least one modulation matrix corresponding to said sector to obtain a plurality of duty cycles for the plurality of electronic switches of said inverter; and
loading said duty cycles into the PWM modulator of said inverter and generating, by means of said PWM modulator, physical signals for driving said switches on the basis of said duty cycles.

23. The method of claim 20, wherein said output electric quantity is an output voltage from said inverter.

24. The method of claim 20, wherein said output electric quantity is an output current from said inverter.

25. The method of claim 20, wherein said inverter is a three-phase inverter.

26. The method of claim 20, wherein said inverter is a multi-level inverter.

27. The method of claim 26, wherein said inverter is a three-level inverter.

28. The method of claim 22 wherein:
for each sector into which the complex plane is subdivided, data are stored for the determination of a number of modulation matrices that depends on the number of levels of the inverter; and
wherein each modulation matrix comprises a number of rows equal to a number of state vectors lying on the edges of each sector into which said complex plane is subdivided and a number of columns equal to the number of branches of the inverter.

29. The method of claim 28, wherein for each sector into which the complex plane is subdivided, data are stored for the determination of L−1 matrices, where L is the number of levels of the inverter.

30. The method of claim 29, wherein said inverter is a three-phase, two-level inverter and wherein said modulation matrices are defined as:

| Sector no. | Matrix S₀_M |
|---|---|
| 1 | $[ \begin{matrix}1 & 0 & 0 \\ 1 & 1 & 0 \\ 0 & 0 & 0 \\ 1 & 1 & 1\end{matrix} ]$ |
| 2 | $[ \begin{matrix}1 & 1 & 0 \\ 0 & 1 & 0 \\ 0 & 0 & 0 \\ 1 & 1 & 1\end{matrix} ]$ |
| 3 | $[ \begin{matrix}0 & 1 & 0 \\ 0 & 1 & 1 \\ 0 & 0 & 0 \\ 1 & 1 & 1\end{matrix} ]$ |
| 4 | $[ \begin{matrix}0 & 1 & 1 \\ 0 & 0 & 1 \\ 0 & 0 & 0 \\ 1 & 1 & 1\end{matrix} ]$ |
| 5 | $[ \begin{matrix}0 & 0 & 1 \\ 1 & 0 & 1 \\ 0 & 0 & 0 \\ 1 & 1 & 1\end{matrix} ]$ |
| 6 | $[ \begin{matrix}1 & 0 & 1 \\ 1 & 0 & 0 \\ 0 & 0 & 0 \\ 1 & 1 & 1\end{matrix} ]$ |

31. The method of claim 30, wherein said inverter is a three-phase, three-level inverter and wherein said modulation matrices are defined as:

| Sector No. | matrix S₀_M | matrix S₁_M |
|---|---|---|
| 1 | $[ \begin{matrix}1 & 0 & 0 \\ 0 & 0 & 0 \\ 1 & 0 & 0 \\ 1 & 1 & 0 \\ 0 & 0 & 0 \\ 1 & 1 & 0 \\ 0 & 0 & 0 \\ 0 & 0 & 0 \\ 1 & 1 & 1\end{matrix} ]$ | $[ \begin{matrix}1 & 0 & 0 \\ 1 & 0 & 0 \\ 1 & 1 & 1 \\ 1 & 1 & 0 \\ 1 & 1 & 0 \\ 1 & 1 & 1 \\ 0 & 0 & 0 \\ 1 & 1 & 1 \\ 1 & 1 & 1\end{matrix} ]$ |
| 2 | $[ \begin{matrix}1 & 1 & 0 \\ 0 & 0 & 0 \\ 1 & 1 & 0 \\ 0 & 1 & 0 \\ 0 & 0 & 0 \\ 0 & 1 & 0 \\ 0 & 0 & 0 \\ 0 & 0 & 0 \\ 1 & 1 & 1\end{matrix} ]$ | $[ \begin{matrix}1 & 1 & 0 \\ 1 & 1 & 0 \\ 1 & 1 & 1 \\ 0 & 1 & 0 \\ 0 & 1 & 0 \\ 1 & 1 & 1 \\ 0 & 0 & 0 \\ 1 & 1 & 1 \\ 1 & 1 & 1\end{matrix} ]$ |
| 3 | $[ \begin{matrix}0 & 1 & 0 \\ 0 & 0 & 0 \\ 0 & 1 & 0 \\ 0 & 1 & 1 \\ 0 & 0 & 0 \\ 0 & 1 & 1 \\ 0 & 0 & 0 \\ 0 & 0 & 0 \\ 1 & 1 & 1\end{matrix} ]$ | $[ \begin{matrix}0 & 1 & 0 \\ 0 & 1 & 0 \\ 1 & 1 & 1 \\ 0 & 1 & 1 \\ 0 & 1 & 1 \\ 1 & 1 & 1 \\ 0 & 0 & 0 \\ 1 & 1 & 1 \\ 1 & 1 & 1\end{matrix} ]$ |
| 4 | $[ \begin{matrix}0 & 1 & 1 \\ 0 & 0 & 0 \\ 0 & 1 & 1 \\ 0 & 0 & 1 \\ 0 & 0 & 0 \\ 0 & 0 & 1 \\ 0 & 0 & 0 \\ 0 & 0 & 0 \\ 1 & 1 & 1\end{matrix} ]$ | $[ \begin{matrix}0 & 1 & 1 \\ 0 & 1 & 1 \\ 1 & 1 & 1 \\ 0 & 0 & 1 \\ 0 & 0 & 1 \\ 1 & 1 & 1 \\ 0 & 0 & 0 \\ 1 & 1 & 1 \\ 1 & 1 & 1\end{matrix} ]$ |
| 5 | $[ \begin{matrix}0 & 0 & 1 \\ 0 & 0 & 0 \\ 0 & 0 & 1 \\ 1 & 0 & 1 \\ 0 & 0 & 0 \\ 1 & 0 & 1 \\ 0 & 0 & 0 \\ 0 & 0 & 0 \\ 1 & 1 & 1\end{matrix} ]$ | $[ \begin{matrix}0 & 0 & 1 \\ 0 & 0 & 1 \\ 1 & 1 & 1 \\ 1 & 0 & 1 \\ 1 & 0 & 1 \\ 1 & 1 & 1 \\ 0 & 0 & 0 \\ 1 & 1 & 1 \\ 1 & 1 & 1\end{matrix} ]$ |
| 6 | $[ \begin{matrix}1 & 0 & 1 \\ 0 & 0 & 0 \\ 1 & 0 & 1 \\ 1 & 0 & 0 \\ 0 & 0 & 0 \\ 1 & 0 & 0 \\ 0 & 0 & 0 \\ 0 & 0 & 0 \\ 1 & 1 & 1\end{matrix} ]$ | $[ \begin{matrix}1 & 0 & 1 \\ 1 & 0 & 1 \\ 1 & 1 & 1 \\ 1 & 0 & 0 \\ 1 & 0 & 0 \\ 1 & 1 & 1 \\ 0 & 0 & 0 \\ 1 & 1 & 1 \\ 1 & 1 & 1\end{matrix} ]$ |

32. The method of claim 20, wherein said modulation matrices are calculated by means of rotation and shift operations from a series of compressed modulation matrices.

33. The method of claim 32, wherein said inverter is a three-phase, two-level inverter and wherein said compressed modulation matrices are defined as
Matrix R₀_M
[13 5 1]
[9 13 1]
as expressed in decimal notation, each decimal number in said matrices converted to binary notation defining a column of a corresponding compressed matrix in binary notation.

34. The method of claim 32, wherein said inverter is a three-phase three-level inverter and wherein said compressed modulation matrices are defined as

| vector no. (X) | matrix Rₓ_M (1) | matrix Rₓ_M (2) |
|---|---|---|
| 0 | [361 41 1] | [507 123 75] |
| 1 | [321 361 1] | [459 507 75] |

expressed in decimal notation, each decimal number in said matrices converted into binary notation defining a column of a corresponding compressed matrix in binary notation.

35. A method of modulating a multiphase inverter wherein the inverter comprises a PWM modulator and plurality of electronic switches, the method comprising:
identifying a rotating vector representing a multi-phase voltage output from the inverter, said rotating vector being defined by a modulation index and by an electric angle in a complex plane;
at each inverter PWM cycle, determining a sector of said complex plane in which said rotating vector is located;
determining a modified phase angle offsetting the phase of the rotating vector until bringing back said rotating vector and the sector in which it lies in a geometric condition coinciding with that of the first sector of the complex plane;
calculating the duty cycle vector as a function of the modified phase angle and of the modulation index of the rotating vector; The method of claim 21, wherein said duty cycle vector is multiplied by a number of modulation matrices determined by a number of voltage levels of said inverter.
executing a row by column product of the duty cycle vector by a number of modulation matrices determined by a number of voltage levels of said inverter;
loading the values obtained from the product between the duty cycle vector and the modulation matrices into the PWM modulator; and
driving the plurality of switches of the inverter as a function of the output PWM signals from said modulator.

36. The method of claim 35, wherein said duty cycle vector and said modulation matrices are multiplied by means of a multiply and accumulate operator.

37. A multiphase inverter comprising:
an inverter input configured to couple to a source of electric energy;
an inverter output configured to couple to an electric power grid;
a plurality of inverter switches;
a control system couple to the plurality of inverter switches, the control system including a PWM modulator; and
wherein the control system is effective to
calculate a duty cycle vector as a function of electric parameters defining a rotating vector representative of an output electric quantity required from the inverter;
multiply the duty cycle vector by a stored modulation matrix to obtain a plurality of duty cycles for the plurality of inverter switches;
loading the duty cycles into the PWM modulator; and
generating physical signals for driving the plurality of inverter switches on the basis of the duty cycles.
